(19) United States
(12) Patent Application Publication
(10) Pub. No.: US 2011/0191153 A1
(43) Pub. Date: Aug. 4, 2011

(54) METHOD AND SYSTEM FOR PRESENTING ADVERTISEMENTS

(75) Inventor: Krishna Prasad Panje, Bangalore (IN)

(73) Assignee: MOTOROLA, INC., Schaumburg, IL (US)

(21) Appl. No.: 12/677,833

(22) PCT Filed: Sep. 10, 2008
(86) PCT No.: PCT/US08/75771

§ 371 Date: Apr. 15, 2011

(30) Foreign Application Priority Data
Sep. 13, 2007 (IN) 1938/DEL/2007

(51) Int. Cl. G06Q 30/00

(52) U.S. Cl. 705/14.4

(57) ABSTRACT

The present invention provides a method for presenting advertisements to a user at an electronic device (106). The method includes identifying (404) the advertisements present in media content. The method also includes generating (406) a play list of the advertisements based on pre-defined rules. Further, the method includes presenting (408) the advertisements to the user in accordance with the play list of advertisements.

The present invention generally relates to electronic devices, and more particularly, to a method and system for presenting advertisements at the electronic device.

### BACKGROUND OF THE INVENTION

In present day world, the use of electronic device has become increasingly common. Examples of electronic device include a television (TV), a digital video recorder (DVR), a personal video recorder (PVR), a time shift recorder, a radio-set, a smart phone, a pager, a computer, a laptop, a Personal Digital Assistant (PDA) and so forth. These electronic devices play media content that is either transmitted from broadcasters or stored at these electronic devices. The media content can be a video or an audio content which can be in a digital or an analog format.

The media content can have advertisements included in it. These advertisements can be played during the commercial breaks between the media content. These advertisements can be audio/video media content presenting a product/service. Promoters and distributors of these advertisements earn revenue, when users watch these advertisements. However, users may get bored after continuously being presented with the advertisements which are of no interest to the users. Hence the users may tend to skip the channel on the electronic device to avoid those advertisements.

There exist methods that resolve the problem of users getting bored. One such method is to automatically change the channel at the electronic device when an advertisement is being played on it. Thereafter, the electronic device returns to the original channel after the advertisements are over. Another method that addresses the above mentioned problem is to play the advertisements based on the preferences of the users. This method determines the preferences of the users based on the kind of advertisements the users like to watch. Further, another method that deals with the problem of users getting bored on watching advertisement involves insertion of programs into the media content at places where the advertisement should have been played. This method then displays the inserted programs at the electronic device instead of the advertisements. The programs that are inserted into the media content are selected by taking inputs from the user of the electronic device.

Although, the above mentioned methods try to minimize the problem of users getting bored on watching advertisements, however, these methods involve skipping and/or substituting the advertisements in between the media content. Nevertheless, the advertisements are meant to be watched by the users for the distributors and promoters of advertisements to earn revenue. Moreover, by using some of the above mentioned methods, same advertisements may get repeated during live media content. This makes it boring for the users to watch the advertisements.

### BRIEF DESCRIPTION OF THE DRAWINGS

The accompanying figures, where like reference numerals refer to identical or functionally similar elements throughout the separate views, and which, together with the detailed description below, are incorporated in and form part of the specification, serve to further illustrate various embodiments and explain various principles and advantages, all in accordance with the present invention.

FIG. 1 illustrates an exemplary communication environment, where various embodiments of the present invention can be practiced;

FIG. 2 illustrates a block diagram of an electronic device, in accordance with an embodiment of the present invention;

FIG. 3 illustrates a block diagram of a media content server, in accordance with an embodiment of the present invention;

FIG. 4 is a flow diagram illustrating a method for presenting advertisements to a user at an electronic device, in accordance with an embodiment of the present invention; and

FIG. 5 and FIG. 6 are flow diagrams illustrating a method for presenting advertisements to a user at an electronic device; in accordance with another embodiment of the present invention.

FIG. 7 illustrates play lists of advertisements, in accordance with an embodiment of the present invention.

Skilled artisans will appreciate that elements in the figures are illustrated for simplicity and clarity and have not necessarily been drawn to scale. For example, the dimensions of some of the elements in the figures may be exaggerated, relative to other elements, to help to in improving an understanding of the embodiments of the present invention.

### DETAILED DESCRIPTION

Before describing in detail the particular method and system for presenting advertisements, in accordance with various embodiments of the present invention, it should be observed that the present invention resides primarily in combinations of method steps related to method and system for presenting advertisements. Accordingly, the apparatus components and method steps have been represented, where appropriate, by conventional symbols in the drawings, showing only those specific details that are pertinent for an understanding of the present invention, so as not to obscure the disclosure with details that will be readily apparent to those with ordinary skill in the art, having the benefit of the description herein.

In this document, the terms ‘comprises,’ ‘comprising’, or any other variation thereof, are intended to cover a non-exclusive inclusion, such that a process, method, article or apparatus that comprises a list of elements does not include only those elements but may include other elements that are not expressly listed or inherent in such a process, method, article or apparatus. An element proceeded by “comprises . . . a” does not, without more constraints, preclude the existence of additional identical elements in the process, method, article or apparatus that comprises the element. The term ‘another,’ as used in this document, is defined as at least a second or more. The terms ‘includes’ and/or ‘having’, as used herein, are defined as comprising.

For an embodiment, a method for presenting advertisements to a user at an electronic device is provided. The method includes identifying the advertisements present in media content. Further, the method includes generating a play list of the advertisements based on pre-defined rules. Moreover, the method includes presenting the advertisements to the user in accordance with the play list of advertisements.

For another embodiment, an electronic device capable of presenting advertisements to a user is provided. The electronic device includes an electronic processor configured to identify the advertisements present in media content. The electronic processor is also configured to generate a play list of the advertisements based on pre-defined rules. Further, the electronic device includes an output unit configured to present the advertisements to the user in accordance with the play list of advertisements.

For yet another embodiment, a media content server capable of managing presentation of advertisements in media content is provided. The advertisements are presented at an electronic device. The media content server includes a receiver configured to receive the media content. The media content includes one or more advertisements. Further, the media content server includes a media content processor configured to generate a play list of the one or more advertisements present in the media content. Moreover, the media content server includes a transmitter configured to transmit the media content along with the play list of advertisements.

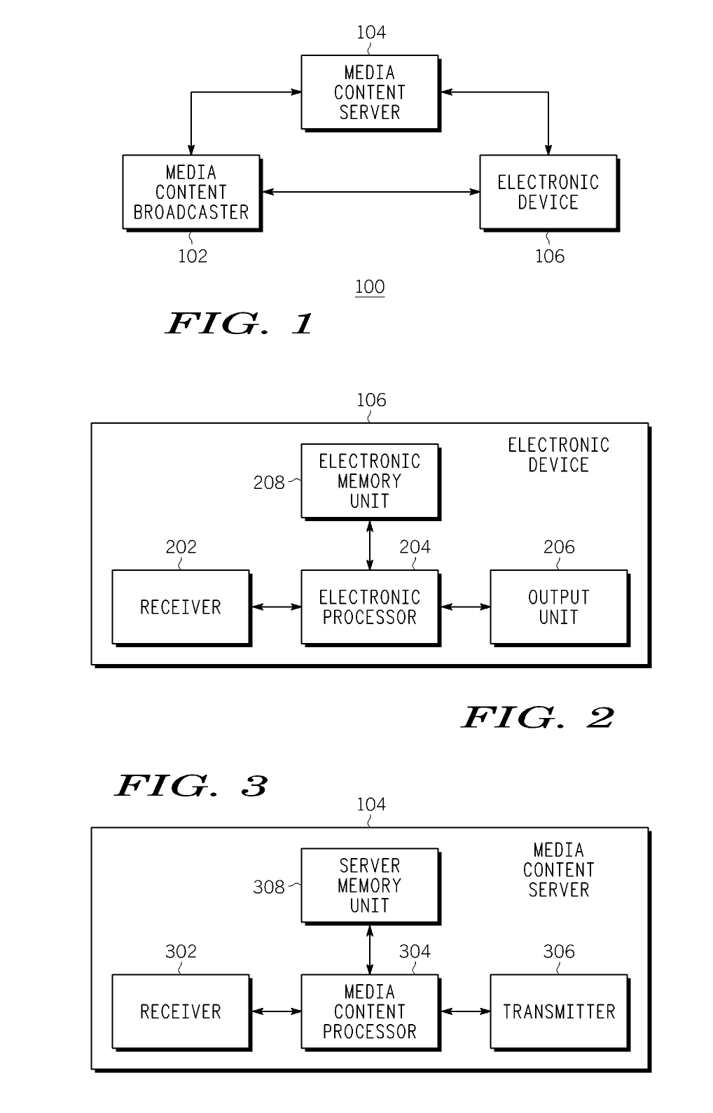

FIG. 1 illustrates an exemplary communication environment 100, where various embodiments of the present invention can be practiced. The exemplary communication environment 100 enables the presentation of advertisements present in the media content to a user. The media content can be any video or audio content which can be in a digital or analog format. The format in which the video media content can be stored include, but not limited to, National Television Standards Committee (NTSC), Phase Alternating Line (PAL), Sequential Color with Memory (SECAM), Motion Pictures Experts Group (MPEG), Advanced Systems Television Committee (ATSC), Integrated Services Digital Broadcasting (ISDB), and so forth. Examples of the audio media content include MPEG audio layer-3 (mp3) audio, windows media audio, realaudio, waveform audio format (way), and so forth. Although, the examples of media content have been mentioned above, any person ordinarily skilled in the art can appreciate that the invention can be practiced with any other suitable format of media content.

The exemplary communication environment 100 is shown to include a media content broadcaster 102, a media content server 104 and an electronic device 106. The media content broadcaster 102 stores and transmits the media content so that users can watch and/or listen to the media content. Examples of media content broadcaster 102 include, but are not limited to, television stations, radio stations, satellite systems, cable systems, servers located in the internet, and so forth. The media content broadcaster 102 can transmit both the audio and video media content to the media content server 104 or the electronic device 106.

The media content server 104 receives the media content from the media content broadcaster 102. The media content server 104 manages the presentation of media content at the electronic device 106. The media content server 104 can be a head-end or a server at the location of a cable service provider which enables the media content to be streamed to the electronic device 106.

The electronic device 106 can receive the media content from either the media content server 104 or directly from the media content broadcaster 102. In an alternative embodiment, the media content may be stored at the electronic device 106. In this embodiment the electronic device 106 retrieves the media content stored within it. The electronic device 106 can be a television (TV), a digital video recorder (DVR), a personal video recorder (PVR), a time shift recorder, a radio-set, a smart phone, a pager, a computer, a laptop, a Personal Digital Assistant (PDA), and so forth. The electronic device 106 can present the media content to the users. The media content that is presented to the users can have advertisements included in it. These advertisements are presented to the users at the electronic device 106. The advertisements are presented to the users in a way such that the users don't get bored of watching same advertisements again and again.

FIG. 2 illustrates a block diagram of an electronic device 106, in accordance with an embodiment of the present invention. The electronic device 106 includes a receiver 202, an electronic processor 204, an output unit 206. Further, the electronic device 106 includes an electronic memory unit 208 configured to store the media content with the advertisements. The electronic device 106 can receive media content from the media content broadcaster 102, the media content server 104, or the electronic memory unit 208. Thereafter, the electronic device 106 presents the media content to the users. The electronic device 106 presents the media content to the users in such a way such that the users don't get bored while watching the media content.

To present the media content to the users, the receiver 202 receives a media content which includes advertisements. For example, when the user has to watch a program on a television, the receiver at the television receives that program in the form of media content. Further, during live presentation of the media content at the electronic device 106, the receiver 202 also receives the information corresponding to the advertisements which are going to be presented during commercial breaks as a metadata along with the media content. For example, if a program is streamed live to the electronic device 106, then the advertisements which will be presented in subsequent commercial breaks are received at the receiver 202 as a metadata within the media content. Further, when the user skips or changes the channel during advertisements between live presentation of media content on the electronic device 106, the skipped advertisements are received at the electronic device 106 on an out of band channel or during the non peak times of the media content traffic. The electronic device 106 can also receive the skipped advertisement by using a second receiver at the electronic device. The second receiver can be an alternate tuner provided at the electronic device 106 such as a television. The media content that is received by the receiver 202 is then sent to the electronic processor 204. The electronic processor 204 identifies the advertisements that are present in the media content. The advertisements can be identified by detecting the locations in the media content. For example, the advertisements can be identified by detecting the time frames after which each advertisement occurs in the media content. The advertisements can be identified by using other suitable methods not disclosed in this application.

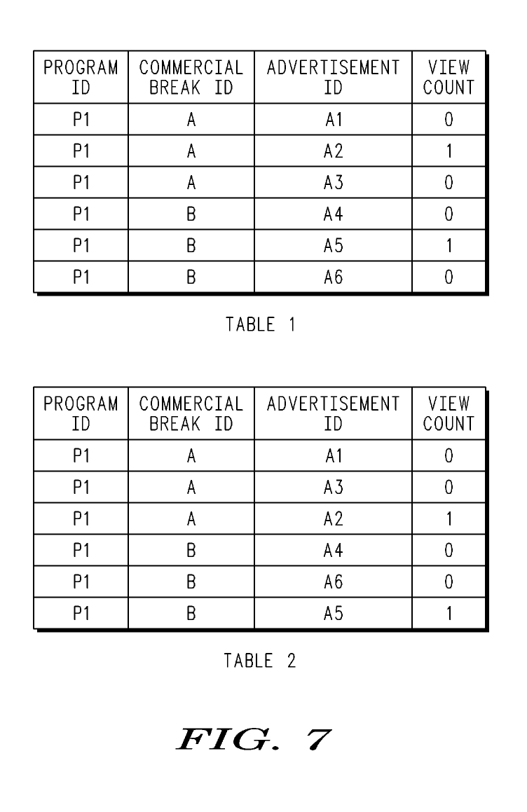

The electronic processor 204 then generates a play list of the identified advertisements. The play list can be any suitable list containing information related to the advertisements. The information can be a sequential order in which the advertisements can be presented to the users. For example, the play list can be similar to the play lists formed by media players such as Windowsmedia™ player, Winamp™, and so forth. In an embodiment, the play list of advertisements can have the fields such as a program identification number, a commercial break identification number. The program identification number is a unique number given to the program. The commercial break identification number is a unique number given to a commercial break in the program. The commercial break identification number specifies the commercial break during which the advertisement is to be displayed. The play list is explained in detail in FIG. 7.

The advertisement identification number can be any unique number given to an advertisement under a commercial break in a program. The advertisement view count is the number of times the advertisement has been presented to the users at the electronic device 106. Whenever an advertisement is presented to the user, its advertisement view count is incremented. The play list can include various fields that can be different in number and type than the list explained above.

The electronic processor 204 generates the play list of advertisement according to predefined rules. For example, the predefined rules can include a rule such that the advertisements presented in a commercial break cannot be presented in a next commercial break. The commercial breaks and the advertisements are identified by using the commercial break identification number and advertisement identification number, respectively. The predefined rules can also include a rule such that an advertisement with least advertisement view count is presented foremost to the user. For example, a sample play list includes the advertisements of product A, product B, and service C. Thereafter, view counts corresponding to advertisements of product A, product B, and service C are compared, and the advertisement with least view count is positioned foremost in the play list. Hence, in the next commercial break the advertisement associated with least view count is presented to the users. Further, the predefined rules can include a rule such that an advertisement cannot be presented more that once in a commercial break.

The electronic processor 204 regenerates the play list of advertisement after each advertisement is presented to the user. The play list of advertisement is regenerated according to the pre-defined rules. In another embodiment the play list of advertisement can be regenerated after a set of advertisements or the media content has been presented to the users. The play list is regenerated to adjust for the modifications in attributes that affect the pre-defined rules. For example, after an advertisement is presented to the user, its advertisement view count changes and it may become necessary to regenerate the play list by using the new advertisement view count of that advertisement.

The electronic processor 204 can also modify the advertisement view count associated with the advertisement based on a set of parameters. The set of parameters can include user's preference to watch the advertisement, the broadcaster's or the content provider's preferences to present the advertisement, and so forth. Moreover, the electronic processor 204 can present the play list of advertisement as a graphical user interface to the user so that the user can choose the advertisement to be presented according to his/her preferences.

Subsequent to the generation of play list of advertisements by the electronic processor 204, the output unit 206 presents the advertisements to the users in accordance with the generated play list of advertisements. The output unit 206 can be a display unit or a speaker unit at the electronic device 106. For example, the output unit 206 can be a monitor, a cathode ray tube (CRT) display, a liquid crystal display (LCD), a speaker, earphones, and so forth.

FIG. 3 illustrates a block diagram of a media content server 104, in accordance with an embodiment of the present invention. The media content server 104 includes a receiver 302, a media content processor 304, a transmitter 306, and a server memory unit 308. The media content server 104 manages the presentation of media content at the electronic device 106. The media content server 104 can receive media content from the media content broadcaster 102, the electronic device 106, and/or the server memory unit 308. Thereafter, the media content server 104 manages the presentation of media content at the electronic device 106 in such a way that the users don't get bored while watching the media content. The media content server 104 can also store the media content as well as the advertisements at the server memory unit 308.

The receiver 302 receives a media content containing the advertisements in it. The receiver 302 can receive the media content through wired or wireless communication link. The received media content along with the advertisements is presented at the electronic device 106. For example, when a program is being presented at the electronic device 106, the receiver at the cable service provider can receive the media content. Further, during live presentation of the media content at the electronic device 106, the receiver 302 also receives the information corresponding to the advertisements which are going to be presented during commercial breaks as a metadata along with the media content. For example, the cable service provider can receive the advertisements which are going to be presented in subsequent commercial breaks at the electronic device 106 as a metadata embedded in the media content.

The media content that is received by the receiver 302 is then sent to the media content processor 304. Thereafter, the media content processor 304 identifies the advertisements that are present in the media content. The advertisements can be identified by detecting the locations in the media content. The advertisements can also be identified by detecting the time frame after which each advertisement occurs in the media content. The advertisements can be identified by using other suitable methods not disclosed in this application.

After receiving the media content, the media content processor 304 generates a play list of the identified advertisements according to the predefined rules. In an embodiment, the play list of advertisements can have the fields such as a program identification number, a commercial break identification number, an advertisement identification number, an advertisement view count, and so forth. Whenever an advertisement is presented to the user, its advertisement view count is incremented. The fields included in the play list can be different in number and type than the list explained above.

The media content processor 304 regenerates the play list of advertisement after each advertisement is presented to the user. The play list of advertisement is regenerated according to the pre-defined rules. The media content processor 304 can also modify the advertisement view count associated with the advertisement based on a set of parameters. The set of parameters include parameters such as user's preference to watch the advertisement, the broadcaster's or the content provider's preferences to present the advertisement, and so forth.

Subsequent to the generation of play list of advertisements by the media content processor 304, the transmitter 306 transmits the media content along with the play list of advertisements to the electronic device 106. The transmitter 306 transmits the media content with a sequence of advertisements in accordance with the play list, to the electronic device 106.

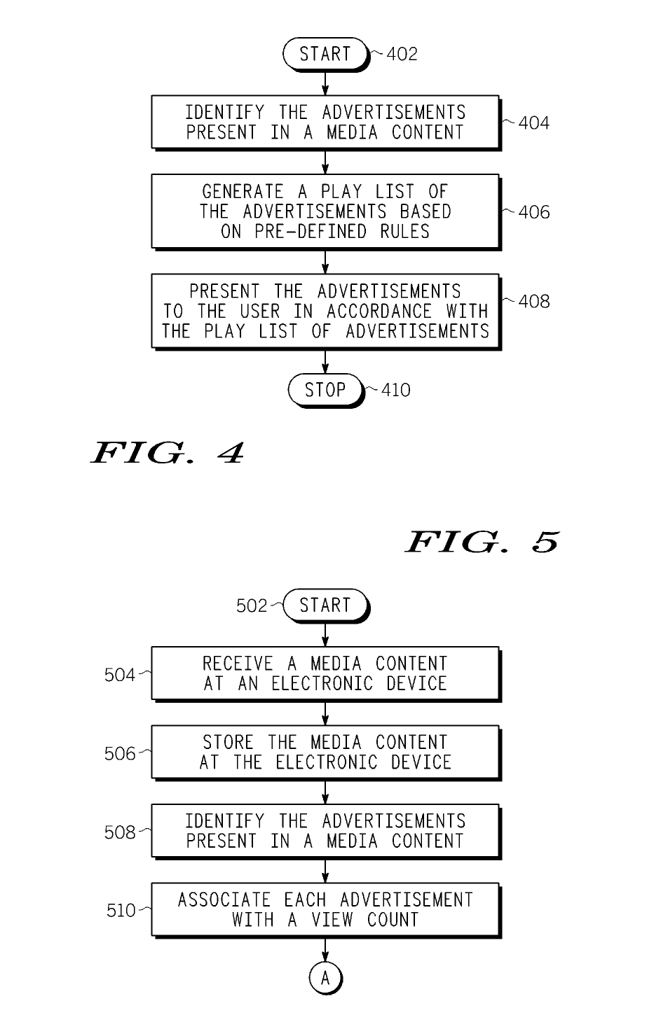

FIG. 4 is a flow diagram illustrating a method for presenting advertisements to a user at an electronic device 106, in accordance with an embodiment of the present invention. The media content is received at the electronic device 106, the media content has advertisements included in it.

The method for presenting advertisements to a user is initiated at step 402. At step 404, the advertisements present in the media content are identified. For example, when the user is watching media content at an electronic device 106 such as a television, the advertisements present in between the program can be identified. The advertisements can be identified by detecting the locations in the media content. The advertisements can also be identified by detecting the time frames after which each advertisement occurs in the media content. At step 406, a play list of the advertisements received with the media content is generated. The play list can be a list containing information pertaining to a sequence of presentation of advertisements. The play list can be generated based on pre-defined rules. For example the play list can be generated in a way such that the advertisements with least view count are presented foremost. In another embodiment the view can be modified based on a set of parameters. For example, the users can modify the view count thereby setting a sequence of the play list. In one embodiment the view count can be modified by using an interactive interface. At step 408, the advertisements are presented to the users in accordance with the generated play list of advertisements. For example, during the presentation of media content, the advertisements are presented to the users in each commercial break. The advertisements are presented in accordance with the play list generated at step 406. The advertisements can be presented to the user at the electronic device 106. The advertisements are presented to the user along with the media content by using an output unit 206 such as a monitor, a cathode ray tube (CRT) display, a liquid crystal display (LCD), a speaker, earphones, and so forth. Thereafter, the method terminates at step 410.

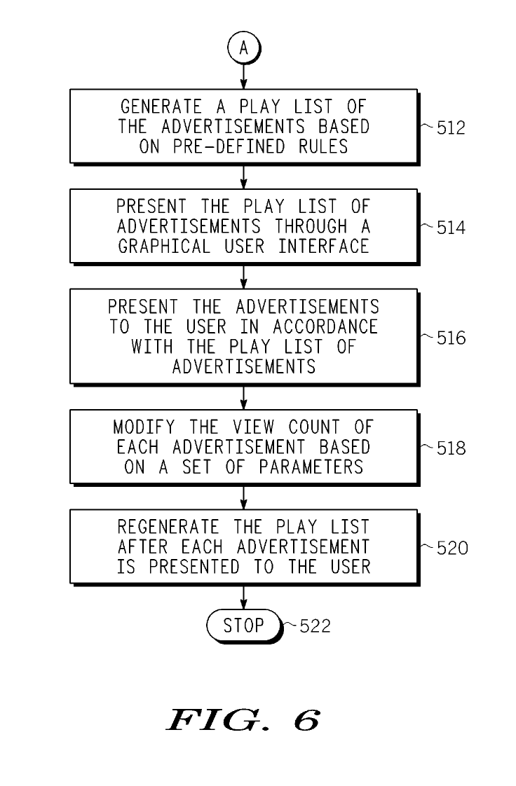

FIG. 5 and FIG. 6 are flow diagrams illustrating a method for presenting advertisements to a user at an electronic device 106 in accordance with another embodiment of the present invention. The method is initiated at step 502. At step 504, the media content is received at the electronic device 106 by the receiver 202. The media content has advertisements included in it. For example, a video of a movie is received from a broadcaster. Along with the movie video, advertisements in between the movies are also received form the broadcaster. The media content can be received from a media content broadcaster 102, a media content server 104, or an electronic memory unit 208. For example, if the user is watching a program that is streamed live, then the electronic device 106 can receive the media content corresponding to that program directly from the broadcaster or through the cable service provider. However, when the user is watching a program on his television which is stored on the television or any other suitable device connected to the television, the media content can be received from that storage device. In other words, the user can also watch a movie from a hard disk drive connected to the electronic device 106.

Further, during live presentation of the media content at the electronic device 106, the advertisements to be presented during commercial breaks are also received as a metadata along with the media content. For example, when a program is streamed live to the electronic device 106, then the advertisements to be presented in subsequent commercial breaks are received at the receiver 202 as a metadata within the media content. Moreover, when the user skips or changes the channel during advertisements between live presentation of media content on the electronic device 106, the skipped advertisements are received at the electronic device 106 on an out of band channel or during the non peak times of the media content traffic. In addition to this, the skipped advertisement can also be received at the electronic device 106 by using a second receiver at the electronic device. The second receiver can be an alternate tuner provided at the electronic device 106 such as a television.

After receiving the media content at the electronic device 106, at step 506, the media content and/or the advertisements can be stored at the electronic memory unit 208. For example, the programs that are received at the television can be stored at a storage device such as a hard disk. At step 508, the advertisements present in the media content are identified by the electronic processor 204. The advertisements can be identified by detecting the locations in the media content where the advertisements are present. The advertisements can also be identified by detecting the time frames after which each advertisement occurs in the media content. The advertisements can be identified by using other suitable methods not disclosed in this application. The advertisements are identified in the media content so that a play list of advertisement can be formed in subsequent steps.

At step 510, each advertisement is associated with an advertisement view count by the electronic processor 204. The advertisement view count is the number of times the advertisement has been presented at the electronic device 106. Hence, whenever an advertisement is presented to the user at the electronic device 106, its advertisement view count is incremented. The advertisement view count is an important factor which is used to generate the play list of advertisement.

Thereafter, at step 512 the play list of advertisements is generated by the electronic processor 204. The play list can be any suitable list containing information related to the advertisements. For example, the play list can be similar to the play lists formed by media players such as Windowsmedia™ player, Winamp™, and so forth. In an embodiment, the play list of advertisements can have the fields such as a program identification number, a commercial break identification number, an advertisement identification number, an advertisement view count, and so forth. The advertisement view count defines number of times the advertisement has been presented to the users. For example, an advertisement is received at the electronic device 106 with the advertisement view count, zero. The advertisement view count is incremented each time the advertisement is presented to the user.

The play list of advertisements is generated according to pre-defined rules. The predefined rules can include a rule such that the advertisements presented in a commercial break cannot be presented in a next commercial break. The commercial breaks and the advertisements are identified by using the commercial break identification number and advertisement identification number respectively. The predefined rules can also include a rule such that an advertisement with least view count is presented foremost to the user. Further, the predefined rules can include a rule such that an advertisement cannot be presented more that once in a commercial break.

At step 514, the play list of advertisements is presented to the user as a graphical user interface by the electronic processor 204. This enables the users to view or modify the presentation sequence of the advertisements to be presented to his/her preferences. For example, the play list of advertisement, which has been generated, can be displayed to the user on the screen of the television. Thereafter, the user can select the advertisements or modify the play list of advertisements by using a remote control or controls provided at the electronic device 106.

At step 516, the advertisements are presented to the user at the electronic device 106 according to the play list of advertisements generated. For example, during the telecast of a program at the electronic device 106 such as a cricket match, the advertisements can be shown in break during the match. The advertisements are presented along with the media content in the sequence generated at step 512 or modified by the user at step 514. The advertisements are presented on the electronic device 106, by using the output unit 206.

At step 518, the advertisement view count of each advertisement can be modified based on a set of parameters. The set of parameters can include incrementing the view count, when the advertisement has been viewed by the user. Further, the set of parameters include parameters such as user's preference to watch the advertisement, the broadcaster's or the content provider's preferences to present the advertisement, and so forth. For example, when a user wants to watch a particular advertisement multiple times, he can modify the advertisement view count. Further, if the broadcaster of the advertisement wants to present a particular advertisement, the advertisement view count can be modified.

At step 520, the play list is regenerated to adjust for the modifications in the set of parameters which are used to generate the play list. The play list of advertisement is regenerated by the electronic processor 204 after each advertisement is presented to the user. The play list of advertisement is regenerated according to the pre-defined rules. The play list of advertisement can also be regenerated after a set of advertisements or the media content is presented to the user. For example, after an advertisement is presented to the user, its advertisement view count changes and it may become necessary to regenerate the play list by using the new advertisement view count of that advertisement.

FIG. 7 illustrates play list of advertisements, in accordance with an embodiment of the present invention. The play list of advertisement has fields such as the program identification number, the commercial break identification number, the advertisement identification number, and the advertisement view count. Table 1 depicts the sequence of advertisements received with the media content when a program having program identification number “P1” is being presented to the user. The program “P1” has two commercial breaks with commercial break identification numbers ‘A’ and ‘B’. The commercial break ‘A’ includes advertisements with advertisement identification numbers ‘A1’, ‘A2’, and ‘A3’. The commercial break ‘B’ includes advertisements ‘A4’, ‘A5’, and ‘A6’. Each of the advertisement has an advertisement view count associated with it as shown.

Table 2 depicts the play list of advertisement generated according to one of the embodiments of the present invention. The advertisement ‘A2’ in commercial break A had a view count of 1, while the advertisement ‘A3’ had a view count of 0 as shown in table 1. Hence, according to the predefined rules, the advertisement with least view count has to be foremost in the play list. Therefore, the advertisement ‘A3’ is moved up in the play list and presented to the user before advertisement ‘A2’, during commercial break ‘A’. Similarly, the advertisement ‘A6’ was moved up and was presented before advertisement ‘A5’ in commercial break ‘B’. In this case the advertisements are arranged intra commercial breaks, i.e. the commercial break ‘A’. In another embodiment the advertisements can be arranged inter commercial breaks. For example the advertisements ‘A4’ and ‘A6’ of commercial break ‘B’ can be moved above the advertisement ‘A2’ of commercial break ‘A’, to make the play list compliant with the predefined rules.

Hence, to account for the modification in the advertisement view count after each advertisement is presented to the users, the play lists are continuously regenerated. The play lists can also be regenerated when there are modifications in the programs, commercial breaks, user's or the promoter's preferences. For example, the advertisement ‘A1’ promotes a product and the advertisement ‘A6’ promotes a service for the product promoted in advertisement ‘A1’. Thus the promoters of the both the advertisements may wish to present them together in a sequence.

Various embodiments of the present invention offer one or more advantages. The advertisements are presented to the users at the electronic device in such a way that the probability of users getting bored after watching the advertisements decreases. Further, the method minimizes the repetition of advertisements during the presentation of the media content. Moreover, with the described advertisement presentation technique, the advertisements are presented to an increased number of users. This may increase the revenue of the distributors and promoters of the advertisements.

It will be appreciated that the method and system for presenting advertisements, described herein, may comprise one or more conventional processors and unique stored program instructions that control the one or more processors, to implement, in conjunction with certain non-processor circuits, some, most, or all of the functions of the system described herein. The non-processor circuits may include, but are not limited to, signal drivers, clock circuits, power-source circuits, and user-input devices. As such, these functions may be interpreted as steps of a method and system for presenting advertisements. Alternatively, some or all the functions can be implemented by a state machine that has no stored program instructions, or in one or more application-specific integrated circuits (ASICs), in which each function, or some combinations of certain of the functions, are implemented as custom logic. Of course, a combination of the two approaches can also be used. Thus, methods and means for these functions have been described herein.

It is expected that one with ordinary skill, notwithstanding possibly significant effort and many design choices motivated by, for example, available time, current technology and economic considerations, when guided by the concepts and principles disclosed herein, will be readily capable of generating such software instructions, programs and ICs with minimal experimentation.

In the foregoing specification, the invention and its benefits and advantages have been described with reference to specific embodiments. However, one with ordinary skill in the art would appreciate that various modifications and changes can be made, without departing from the scope of the present invention, as set forth in the claims below. Accordingly, the specification and the figures are to be regarded in an illustrative rather than a restrictive sense, and all such modifications are intended to be included within the scope of the present invention. The benefits, advantages, solutions to problems, and any element(s) that may cause any benefit, advantage or solution to occur or become more pronounced are not to be construed as critical, required or essential features or elements of any or all the claims. The invention is defined solely by the appended claims, including any amendments made during the pendency of this application, and all equivalents of those claims, as issued.

What is claimed is:

1. A method for presenting advertisements to a user at an electronic device, the method comprising:
identifying the advertisements present in a media content;
generating a play list of the advertisements based on pre-defined rules; and
presenting the advertisements to the user in accordance with the play list of advertisements.

2. The method as recited in claim 1 further comprising receiving the media content at the electronic device.

3. The method as recited in claim 2, wherein the media content is received from at least one of an electronic memory unit located at the electronic device, a media content server and a media content broadcaster.

4. The method as recited in claim 1 further comprising storing the media content at the electronic device.

5. The method as recited in claim 1 further comprising regenerating the play list after each advertisement is presented to the user.

6. The method as recited in claim 1 further comprising associating each advertisement with a view count.

7. The method as recited in claim 6 further comprising modifying the view count of each advertisement based on a set of parameters.

8. The method as recited in claim 1, wherein the pre-defined rules include at least one of:
a rule such that the advertisements presented in a commercial break cannot be presented in a next commercial break;
a rule such that an advertisement with least view count is presented foremost to the user; and
a rule such that an advertisement cannot be presented more that once in a commercial break.

9. The method as recited in claim 1 further comprising presenting the play list of advertisements through a graphical user interface.

10. An electronic device capable of presenting advertisements to a user, the electronic device comprising:
an electronic processor configured to:
identify the advertisements present in a media content; and
generate a play list of the advertisements based on pre-defined rules; and
an output unit configured to present the advertisements to the user in accordance with the play list of advertisements.

11. The electronic device as recited in claim 10 further comprising an electronic memory unit configured to store the media content.

12. The electronic device as recited in claim 10 further comprising a receiver configured to receive the media content.

13. The electronic device as recited in claim 12, wherein the media content is received from at least one of:
a media content server;
a media content broadcaster; and
an electronic memory unit located at the electronic device.

14. The electronic device as recited in claim 10, wherein the electronic processor is further configured to regenerate the play list after each advertisement is presented to the user.

15. The electronic device as recited in claim 10, wherein the electronic processor is further configured to associate the advertisements with a view count.

16. The electronic device as recited in claim 15, wherein the electronic processor is further configured to modify the view count of the advertisements based on a set of parameters.

17. The electronic device as recited in claim 15, wherein the pre-defined rules include at least one of:
a rule such that the advertisements presented in a commercial break cannot be presented in a next commercial break;
a rule such that an advertisement with least view count is presented foremost to the user; and
a rule such that an advertisement cannot be presented more that once in a commercial break.

18. The electronic device as recited in claim 10, wherein the electronic processor is further configured to present the play list of advertisements through a graphical user interface.

19. A media content server capable of managing presentation of advertisements in a media content, wherein the advertisements are presented at an electronic device, the media content server comprising:
a receiver configured to receive the media content, wherein the media content comprises one or more advertisements;
a media content processor configured to generate a play list of the one or more advertisements present in the media content; and
a transmitter configured to transmit the media content along with the play list of advertisements.

20. The media content server as recited in claim 19, wherein the media content processor is further configured to identify the advertisements present in the media content.

21. The media content server as recited in claim 19 further comprising a server memory unit configured to store the media content.

22. The media content server as recited in claim 19, wherein the media content is received from at least one of:
the electronic device;
a server memory unit located at the media content server; and
a media content broadcaster.

23. The media content server as recited in claim 19, wherein the media content processor is further configured to associate the advertisements with a view count.

24. The media content server as recited in claim 23, wherein the media content processor is further configured to modify the view count of the advertisements based on a set of parameters.

25. The media content server as recited in claim 19, wherein the pre-defined rules includes as least one of:
a rule such that the advertisements presented in a commercial break cannot be presented in a next commercial break;
a rule such that an advertisement with least view count is presented foremost to a user; and
a rule such that an advertisement cannot be presented more that once in a commercial break.

26. The media content server as recited in claim 19, wherein the transmitter is further configured to transmit the media content with a sequence of advertisements in accordance with the play list.
